(19) United States
(12) Patent Application Publication
(10) Pub. No.: US 2022/0122047 A1
(43) Pub. Date: Apr. 21, 2022

(54) Asset-Backed Electronic Currency Systems and Methods

(71) Applicant: Gary G. Makowski, Huntsville, AL (US)

(72) Inventor: Gary G. Makowski, Huntsville, AL (US)

(21) Appl. No.: 17/533,923

(22) Filed: Nov. 23, 2021

Related U.S. Application Data
(63) Continuation-in-part of application No. 16/387,371, filed on Apr. 17, 2019, now Pat. No. 11,182,775.

(51) Int. Cl. G06Q 20/06; G06Q 20/10; G06Q 20/02

(52) U.S. Cl. CPC G06Q 20/0658; G06Q 20/02; G06Q 20/10

(57) ABSTRACT

A cryptocurrency system [a] One or more Creator Computing Devices, [b] One or more Asset-Backed Computing Devices, [c] One or more Initial Transaction Computing Devices, [d] One Certifier Entity employing a Certifier Computing Device, and [e] One or more Block-Chain Verifier Computing Devices.

### CROSS-REFERENCE TO RELATED APPLICATION

This application is a continuation-in-part and claims priority to U.S. Pat. No. 11,182,775 entitled Asset-Backed Electronic Currency Systems and Methods and filed on Apr. 17, 2019, which is incorporated herein by reference.

### BACKGROUND

Cryptocurrency is being used more and more and transactions between entities tend to be electronic. It is essentially a digital currency that employs encryption to regulate the generation of the cryptocurrency and verify the transfer of funds. In cryptocurrency all transactions that are verified are attached to a public ledger called a block chain, which memorializes all transactions that occur through cryptocurrency. Cryptocurrency is not government issued money. Instead, it is created and held electronically.

Users of cryptocurrency can perform transactions using their cryptocurrency. In this regard, one could buy goods or services on the Internet. The transactions of sales where there is a decrease or an increase in an owner's cryptocurrency are kept in the block chain.

Bitcoin is the oldest and thus the most used cryptocurrency. To participate in bitcoin transactions, a user purchases a pot of bitcoins with government issued money (or they may receive bitcoins for maintaining the bitcoin block chain). The user can then use the bitcoins on the Internet.

### BRIEF DESCRIPTION OF THE DRAWINGS

The present disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram depicting an asset-backed electronic currency system in accordance with an embodiment of the present disclosure.

FIG. 2 is an exemplary block chain used by the system depicted in FIG. 1.

FIG. 3 is a block diagram of a creator computing device of FIG. 1.

FIG. 4 is a block diagram of an asset-backed currency computing device of FIG. 1.

FIG. 5 is a block diagram of an initial transaction computing device of

FIG.

FIG. 6 is a block diagram of a certifier computing device of FIG. 1.

FIG. 7 is a block diagram of a block chain verifier computing device of FIG. 1.

FIG. 8 is a block diagram depicting the exemplary architecture and functionality of the asset-backed currency system disclosed in this document.

### DETAILED DESCRIPTION

The present disclosure describes asset-backed electronic currency systems and methods. In an embodiment, logic creates electronic coins upon request by a legal person (the “creator”). The system levies creation fees against the creator for supporting the system operation and maintenance. Each coin created is backed by an asset, e.g., real property (the equity remaining after any remaining mortgage amount), put forth by the creator. Also, the system creates links for and maintains a block list that comprises all electronic currency transactions.

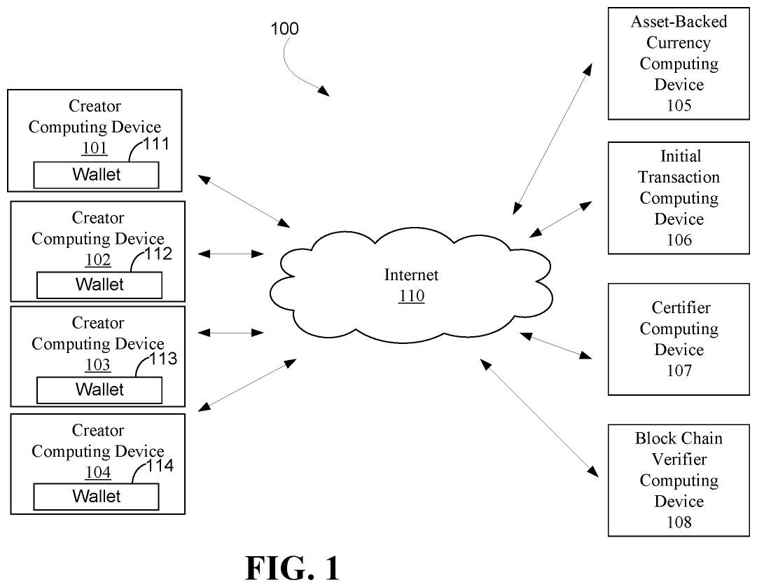

FIG. 1 is a block diagram depicting an asset-backed electronic currency system 100. The system 100 comprises a plurality of creator computer devices 101-104. Note that four creator computer devices are shown; however more or fewer creator computing devices are anticipated in other embodiments of the present disclosure.

Each creator computing device 101-104 has a corresponding electronic wallet 111-114. An electronic wallet comprises memory and a processor and is reserved for tracking coins as the coins go through transactions. In this regard, the creator computing device 101 may initially back 100 coins (backing is described further herein). As the creator computing device 101 receives or gives away coins within the wallets 111-114, the number of coins is incremented or decremented accordingly. The creator computing device and its wallet are used by all coin owners. A coin owner may have created the coins or may have acquired them.

The system 100 further comprises an asset-backed currency computing device 105, an initial transaction computing device 106, a certifier computing device 107, and a block chain verifier computing device 108. Devices 105-108 are communicatively coupled to the creator computer devices 101-104 via a network 110, e.g., the Internet. In one embodiment, there are multiple block chain verifiers.

The asset-backed currency computing device 105 creates asset-backed electronic currency in the form of electronic coins, performs transactions using the coins, and backs the coins requested with assets. Note that the network shown is the Internet 110; however, other networks or types of networks may be used in other embodiments of the present disclosure.

The initial transaction computing device 106 oversees the creation of coins. In this regard, the initial transaction computing device 106 collect fees for creating the coins (a “creation fee”).

The certifier computing device 107 handles the backing of coins (coin certification). Further, the certifier computing device 107 handles the removal of the backing (coin decertification). The certifier computing device 107 levies fees for certification and fees for de-certification.

Once fees have been collected by the initial transaction computing device 106, the certifier computing device 107 contractually constrains the assets identified by the initial transaction computing device 106. In exchange for certification of the asset, the certifier computing device 107 levies a one-time fee (the “certification fee”) against the creator. In operation, the certifier computing device 107 assigns a certification identifier to each coin created, which can be a string of numbers or alphanumeric characters. Note that the contract that pledges assets as coin backing can be terminated provided that the asset owners pay a termination fee to the certifier computing device 107. Also note, in one embodiment, the certification identifier needs to be included in each transaction involving the coin to which it is given. The fundamental documents that are the basis for certification may be paper documents that may be notarized, or they may be electronic digitally signed documents. Paper documents are preferable. Secondary documents that support the fundamental documents include titles, assessed value documents, and various accounting documents. Thereafter, smart contracts, smart bonds, and smart titles may be used for certification.

Note that the assets designated as coin backing by a creator are not collateral. No one is loaning anything to the creator or to the certifier. The creator is simply creating and issuing coins by the creator's own actions. Therefore, the assets designated as coin backing are not collateral for a loan.

Further note that the system 100 comprises the devices 105-108 as separate and distinct devices. However, in other embodiments functionality of a portion or all devices 105-108 may be included on a single computing device. In this regard, FIG. 1 depicts the functionality of the devices decentralized for ease of discussion. There would often be multiple block chain verifier computing devices competing for transaction fees. These devices would not constitute a single computing device.

After creation of the coins by the creator, the asset-backed currency computing device 105 transfers data indicative of a creation fee and the number of coins created to the initial transaction computing device 106 and to one or more block chain verifier computing devices 108. A transaction fee and a block verification fee are taken from the creation fee as described further herein.

Upon creation of electronic coins by the creator, the initial transaction computing device 106 computes a creation fee. The initial transaction computing device 106 levies the creation fee against the creator for each coin created. The creator can pay the creation fee online through a credit card, debit card, or PayPal®.

Additionally, the asset-backed currency computing device 105 transfers data indicative of creation of coins or a transaction involving electronic coins to one or more block chain verifier computing devices 108. A block chain verifier computing device 108 creates an electronic block, verifies the data in the block, and creates an entry for the creation or transaction in a block list. In one embodiment, this block list is public. In this regard, a block of the present disclosure comprises the following:
(1) Zero or more coin creation transactions;
(2) Zero or more spending transactions;
(3) Zero or more certification identifiers & supporting information.
(4) Zero or more decertification identifiers & supporting info.
(5) Computational proof of work; and
(6) Reference to the chronologically prior block.

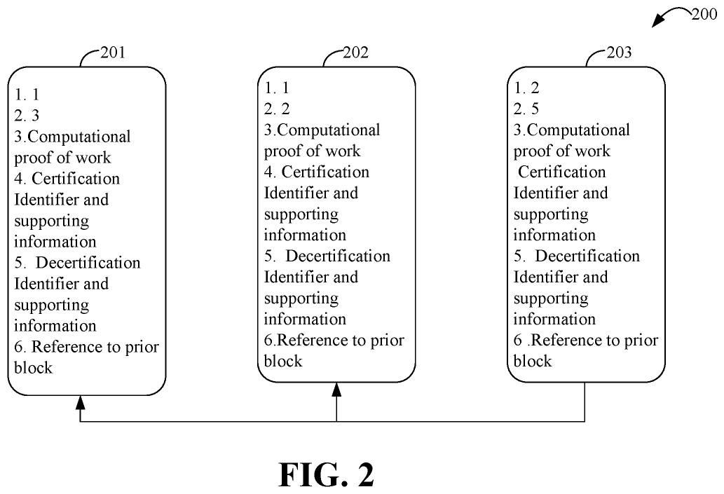

Note that successive additions of blocks representing coin creation and transactions results in a linked chain of block transactions, as shown in FIG. 2. The block chain shall contain every creation and/or transaction dealing with the electronic coin created by the creator. For an electronic coin to be used in transactions, it must be represented in a block in the block chain. In one embodiment, a single transaction entity may be used to maintain an electronic coin block chain. In another embodiment, multiple independent transaction entities maintain tentative block chains. The accepted block chain is determined by public consensus (as it is for bitcoin). It is usually the longest among those tentative block chains.

In one embodiment, the block chain verifier computing device 108 that successfully satisfies the “proof of work” requirement and adds the block to the block chain levies a transaction fee against the creation fee. The transaction fee is to fund the subsystem (community of successful block chain verifiers satisfying “proof of work” requirements) that maintains the block chain.

In one embodiment, most of the creation fee is used to support the integrity of the block chain. In this regard, as discussed, the creation fee is levied against the creator by the initial transaction computing device 106. Most of this fee is awarded to the block creator-verifier who ultimately validates the related transaction by incorporating the representative block into the block chain.

With reference to FIG. 2, an exemplary block chain 200 is illustrated. The most recent block 203 comprises data indicative of 2 coin creation transactions, five spending transactions, computational proof of work (described further herein), and a pointer or reference to the prior block 202. Each block 201-203 comprises the same data types. Note that the block chain 200 is a publicly available data. Note that the owner of the coins represented by the blocks 201-203 is not indicated in the block data.

Furthermore, creators may perform transactions related to their coins. For example, perform a buy or a swap. A The block chain verifier computing device 108 verifies the transaction and adds information related to the transaction in a block in the block chain. Associated with the transaction, the creator is levied a transaction fee, which is used to reward the block chain verifier (computing device) that successfully satisfied the “proof of work” and added the block to the block chain.

Referring to FIG. 1, once the request for electronic currency by the creator is complete, the initial transaction computing device 106 creates the electronic coins. In one embodiment, the asset-backed currency computing device 106 transmits data to the certifier computing device 107 indicating the asset that is to be used by the certifier computing device 107 to certify the asset. In another embodiment, the initial transaction computing device refers the creator to the certifier, so the creator can deal directly with the certifier. The certifier computing device 107 facilitates, manages, and records the backing of the coins.

In return for certifying a given number of coins, the certifier computing device 107 facilitates in contractually constraining the assets indicated. Note that to certify assets, the certifier computing device 107 may request a certification fee. In one embodiment, the certification fee may be some small percentage of the contractually reserved assets.

In one embodiment, the certifier computing device 107 facilitates decertification by the owner of the coins. In exchange for decertification, the coins are cashed out. The certifier computing device electronically disperses to the creator the cash value of the coins decertified minus a decertification fee levied by the certifier computing device 107.

Note that as discussed herein a unique string is associated with the coins created. When decertification occurs, the string continues to identify the coins regardless of decertification.

As discussed herein, the certifier computing device 107 performs the certification of the backing to support coins created by the asset-backed currency computing device 105. In performing certification, the certifier computing device 107 follows equations. For purposes of clarity, the number of coins that the certifier computing device 107 certifies is called the “certified backing.” Certified backing is measured in coins and is determined by the one of the following algorithm:

Certified Backing=ALCV×C_{PL}×C_{FRAC}×C_{LLR}×AVF

where ALCV is the asset local currency value, C_PL is the pledged fraction, C_FRAC is the coin fraction, C_LCR is the coin local currency ratio, and AVF is the asset volatility factor.
The ALCV value is an estimated value of the asset in some local (government-issued currency), e.g., the U.S. dollar. The certifier, with input from the user, determines the ACLV, and inputs that ACLV into the certifier computing device 107. The C_PL value is the fraction of the ALCV that is pledged by the user for coin backing. The pledged value, in the currency specified by the ALCV, is the product of ALCV and C_PL.

The C_FRAC value is a fraction of the pledged value that is acceptable to the user and the Certifier to use as coin backing. In one embodiment, this value is between 0.3 and 1.0. This value reflects the value of the asset being used as backing. For example, setting this fraction to 0.5 means that there is far more asset value backing coins than at which the coins are valued. Note that the range 0.3-1.0 is merely exemplary, and other values may be used in other embodiments of the present disclosure.

C_LCR is a ratio, which is the fractional number of certified coins that correspond to one unit of the local currency. For example, in the United States, the C_LCR is the fractional number of certified coins that correspond to one U.S. dollar. For each local currency, the C_LCR is set by the certifier. This number will fluctuate just as currencies often fluctuate in value. The C_LCR may be periodically adjusted by the certifier to account for such currency fluctuations, or other fluctuations.

AVF is a fractional multiplier used by a user to decrease the amount of coin it will certify because of past volatility for asset of the type being used for backing. The AVF number is always positive and less than or equal to one.

In one embodiment, the certifier computing device 107 pools all assets that are contractually pledged to support coin certification. These are the coin backing assets (C_BA), and the pool is the coin backing asset pool (C_BAP). The certifier computing device 107 determines whether an asset qualifies as a C_BA by determining whether the asset owner agrees contractually to hold free and clear title to the asset, with no liens, mortgages or other encumbrances, and the owner agrees to pay coin decertification maintenance fees in the unlikely event that some coins are decertified.

It is important to note here that certified coins are backed by the pool, not by the specific assets contractually pledged by the creator to support certification of the coins.

As indicated hereinabove, the certified coin owner may desire to decertify and obtain cash value for the coins owned. In this regard, the certified coin owner logs onto the certifier computing device 107 and provides input indicating that the certified coin owner desires to decertify all or a portion of his/her coins.

In response, the certifier computing device 107 provides a graphical user interface (GUI) to the creator computer device 101 that displays CDV_USD, the coin decertification value in USD. That value is set by the certifier. Its default value is 1/C_LCR, expressed in USD (per coin). The GUI may comprise a variety of ways in which the user can receive monetary value for his/her decertified coins. For example, the certifier computing device 107 may deposit a dollar equivalent in a checking account indicated by the creator computer device 101 minus a decertification fee.

Note that the decertification fee is a small percentage of the current value of the coins being decertified. The decertification fee assessment is made to encourage creators to sell the coins through independent transfer. Additionally, decertification reduces the number of coins backed by assets whereas independent exchange results in all coins-still being backed by assets.

When coins are cashed out, the certifier computing device 107 transmits a message to all creator computer devices 101-104 requesting an offset value to recoup the value transferred by the certifier to the owner of the coins being decertified. This is fee is indicated as a coin decertification maintenance fee.

In this regard, a decertification maintenance fee is levied on creators (or other holders of backing assets) to compensate the certifier for decertified coins. To accurately account for the value of decertified coins, the certifier computing device 107 removes the value of the decertified coins from the backing asset obligations of all creators (or other backing asset holders) with active pledge agreements.

As noted hereinabove, a creator enters a contract with the entity that controls the certifier computing device. In the contract, the creator pledges assets owned by the creator as backing for some number of coins. At the time of creation of the coins under contract, the present amount of the coins that are certified is set to the value of the certified backing (CB). For example, if the creator pledges a piece of property valued at $12,000 and the certifier calculates a certified backing of $10,000 based on that property, then the certifier will certify an amount coins corresponding to $10,000 (USD). Thus, a coin backing asset contract instance is the event where a creator pledges assets owned by the creator as backing for some amount of coin (C_BA_CI), and a coin backing asset contract instance current amount is the current number of coins for which the creator is obligated to provide backing (C_BA_CI_CA). At the time of certification, the coin backing asset contract instance current amount is set to the value of the coins of the certified backing. The TOTAL Full-Coin Backing Asset Contract Instance Current Amount (TOTAL_FC_BA_CI_CA) is defined to be sum of all the Full-Coin Backing Asset Contract Instance Current Amounts (where that sum is taken over all:FC_BA_CI's where the asset pledge agreement is still applicable.) This quantity is measured in Full-Coins.

Suppose that each asset in the BAP corresponds to a single FC_BA_CI. Let M represent the total number of assets in the BAP (where the corresponding asset pledge is still in effect.) For each asset k, let FC_BA_CI_CAₖ represent the FC_BA_CI_CA corresponding to that asset. Then the TOTAL Full-Coin Backing Asset Contract Instance Current Amount (TOTAL_FC_BA_CI_CA) is calculated as follows:

TOTAL_FC_BA_CI_CA≡Σ_{k=1 . . . M} FC_BA_CI_CAₖ

When a coin owner decertifies a coin, the coin owner's backing asset contract instance current amount is adjusted downward by a coin decertification maintenance fee paid to the certifier by the creator based on the coin backing asset contract instance. In this regard, for a given coin backing asset contract instance (C_BA_CI), the current amount is adjusted downwards by a coin decertification maintenance fee paid to the certifier by the creator on behalf of the given coin backing asset contract instance. The coin backing asset contract instance current amount (C_BA_CI_CA) is measured in coins. As the coin backing asset contract instance current amount is adjusted downwards, the percentage portion of the pledged assets that are obligated to serve as coin backing is commensurately reduced.

Suppose that each asset in the BAP corresponds to a single FC_BA_CI. Let M represent the total number of assets in the BAP (where the corresponding asset pledge is still in effect.) For each asset k, let ALCV_USDₖ represent that asset's current value in USD. And let PL_FRACₖ, represent the Pledged Fraction for that asset. Then BAP_USD, the value, in USD, of the Full-Coin Backing Asset Pool, is calculated as follows:

BAP_USD≡Σ_{k=1 . . . M} ALCV_USDₖ·PL_FRACₖ

The Current Value of the Full-Coin Backing Asset Pool in USD, BAP_USD, will usually substantially exceed TOTAL_FC_BA_CI_CA when that latter quantity is converted into USD. This reflects a conservative coin backing approach.

As noted, the certifier computing device 107 further determines the coin decertification maintenance fee. Note that the decertification maintenance fee is levied in a particular time interval, and the decertification maintenance fee is approximately equal to the value transferred by the certifier computing device 107 to the owners of certified coins being decertified in that time interval.

The total Full-Coin Decertification Maintenance Fees levied in a given time interval approximately equals the value transferred by the CERTIFIER to the owners of Full-Coins being decertified in that time interval. We rename that total fee as the “Total_Time_Interval_DMF”. For a given time interval and for a given FC_BA_CI, the Full-Coin Decertification Maintenance Fee is calculated as follows:

$$Full \text{-} Coin Decertification Maintenance Fee ≡ {Total\_Time \_Interval \_DMF}_{( for given time interval )} • FC\_BA \_CI \_ {CA / TOTAL\_FC \_BA \_CI \_}_{( for given FC\_BA \_CI )} CA$$

In this regard the decertification maintenance fee is equal to the total time interval decertification maintenance fee multiplied by the coin backing asset contract instance current amount divided by the sum of all current amounts, TOTAL_FC_BA_CI_CA. This fee is levied on each creator (or backing asset holder) who is still present in the coin pool.

When the FC_BA_CI_CAs for all FC_BA_CI_CAs associated with a given asset are zero, then that asset is removed from the FC_BAP. Full-Coin Backing Asset Pool Realignment is the removal from the FC_BAP of one or more such assets.

In one embodiment, the certifier computing device 107 stores all data related to the coins backed by the asset pool. In one embodiment, this data is kept public. The data available by the creator computing devices 101-104 may include coin identifiers, date of certification, coin owners name, a wallet address, and coin asset backing descriptive data. Note that each creator is allocated a wallet address, an address that identifies the creator's coin holding, i.e., the creator's wallet, at the time of coin creation.

In one embodiment, a creator can request electronically to approve the replacement of the coin backing assets by other assets owned by the creator. It is the certifier's decision (the user of the certifier computing device 107) to approve such replacement. If the replacement is approved, the newly identified assets are subject to the same conditions as are assets pledged as backing for newly created coins. In one embodiment, information concerning the replacement backing assets would be made publicly available by the certifier computing device 107.

In one embodiment, the certifier may approve the replacement of the owners of the coin backing assets by other owners of assets. These other owners would provide coin backing assets and submit to the certification process described above for the coins.

In one embodiment, in the case where there is a deceased owner, a new owner would replace the deceased owner. In one embodiment, the assets offered by the replacement owner(s) might be the same assets that were owned by the former coin backing asset holder. For example, those who inherit the estate may become the owners of the coins previously owned by the deceased.

Notably, the phrase coin backing assets holder (C_BAH) refers to the current owners of the assets pledged as coin backing. Upon the death of a coin backing asset holder, the estate of the coin backing asset holder is the replacement coin backing asset holder. The inheritors of the coin backing assets can request to be designated as the replacement as the coin backing asset holder for the coins backed by the assets.

If all the inheritors of the coin backing assets do not wish to serve as the coin backing asset holder, the certifier computing device 107 levies a coin backing asset termination fee on the holders. For each coin backing asset contract instance the fee is the coin backing asset contract instance current amount. This amount is measured in coin but can be expressed as an equivalent of U.S. dollars determined at the time of termination.

Note that the system 100 describes functionality spread across four computing devices 105-108. However, in another embodiment of the present disclosure the functionality ascribed to each of the computing devices 105-108 could reside on a single computing device.

Furthermore, in system 100 there is one asset-backed currency computing device 105, one initial transaction computing device 106, one certifier computing device 107, and one block chain verifier computing device 108. In other embodiments, there may be multiple devices of devices 105-108. However, in other embodiments of the system 100 there may be more devices 105-108 the perform the described functionalities and different entities.

As an example, assume that there is certifier one and certifier two. Each of these certifiers have certifier computing devices like certifier computing device 107. In such an example, a coin denomination refers to the set of coins certified by a given certifier. A coin can be certified by at most one certifier. Thus, certifier one is allocated a very large set of certification identifiers. Assume certifier one is allocated identifiers CNS_1 (a number of integers for allocating to coins), and certifier two is allocated identifiers CNS_2. These sets of identifiers must be disjoint sets of identifiers.

In one exemplary embodiment, CNS_1 could be the set of all hexadecimal integers that begin with digit “1.” CNS_@ could be the set of all hexadecimal integers that begin with digit “2.” In another embodiment, CNS_1 could be the set of all alphanumeric strings of no more than 30 characters that begin with the string CNS_1, and CNS_2 could be the set of all alphanumeric strings of no more than 30 characters that being with the string CNS_2.

Note that these are merely exemplary. Certification numbers may vary in other embodiments. Notably, though, the sets of identifiers CNS_1 and CNS_2 must be disjoint sets.

As indicated hereinabove, some of the functionality of the devices 105-108 may be incorporated into a single device. However, for integrity, in one embodiment, the creation functionality and the certification functionality should be provided by different devices and entities.

Thus, the asset-back currency computing device 105 and the initial transaction computing device 106 may be integrated into a single device that performs the functions of the devices of devices 105 and 106.

Likewise, there could be only one transaction device that incorporates the functionality of the initial transaction computing device 106 and the block chain verifier computing device 108.

Note however, there can be only a single certifier and certifier computing device 107. The certifier computing device 107 sets the denomination and backed value for the set of coins.

Further note that in one embodiment, separate legal entities own and operate the asset-backed currency computing device 105, the initial transaction computing device 106, the certifier computing device 107, and the block chain verifier computing device(s) 108. However, ownership and operation of the computing devices 105-107 may be consolidated. It is important to note, however, that the certifier and the certifier computing device 107 be owned and operated by an entity separate and apart from the other devices.

In one embodiment of the present disclosure, the certifier computing device 107 uses a divisible serial number system to identify the coins created. In this regard, let EC represent one standard unit of e-currency or coin. In such example, suppose that the certifier computing device 107 is certifying 1000 units of EC. In such example, the identifying numbers must be a positive integer. Thus, in the example, the 1000 identifiers may be 8137, 8138, 8139, . . . , 9135, 9136.

Suppose that the owner of the ECs having the 1000 identifiers desires to pay 31% of 8742 to a first recipient, pay 67% of the EC to a second recipient and offer 2% of the EC as a transaction fee to the initial transaction computing device 106. Thus, the EC 8742 is partitioned into 100 fractional parts (FP) of equal value. The serial numbers of the fraction parts are then assigned by the initial transaction computing device 106 as 8742.00, 8742.01, 8742.02, . . . , 8742.98, and 8742.99.

The initial transaction computing device 106 assigns the fraction parts to the recipients. In this regard, the fractional parts numbered 8742.00-8742.30 are assigned to the first recipient, the fractional parts numbered 8742.31-8742.97 are assigned to the second recipient, and the fractional parts number 8742.98 and 8742.99 are designated as the transaction fee.

Note that the fractional part with identifier 8742 is worth one standard unit of EC. The fractional part with serial number 8742.0 is worth on tenth of an EC, and the fractional part with identifier 8742.000 is worth one thousandth of an EC.

Thus, the number of digits to the right of the decimal point determines what fraction of an EC the fractional part is worth. If there is no decimal point, the fraction part is worth one EC. If there is one digit to the right of the decimal point, the fractional part is worth one tenth of an EC. If there are two digits to the right of the decimal point, the fractional part is worth one hundredth of an EC. If there are M digits to the right of the decimal point, the fractional part is worth 10^{-M} of an EC.

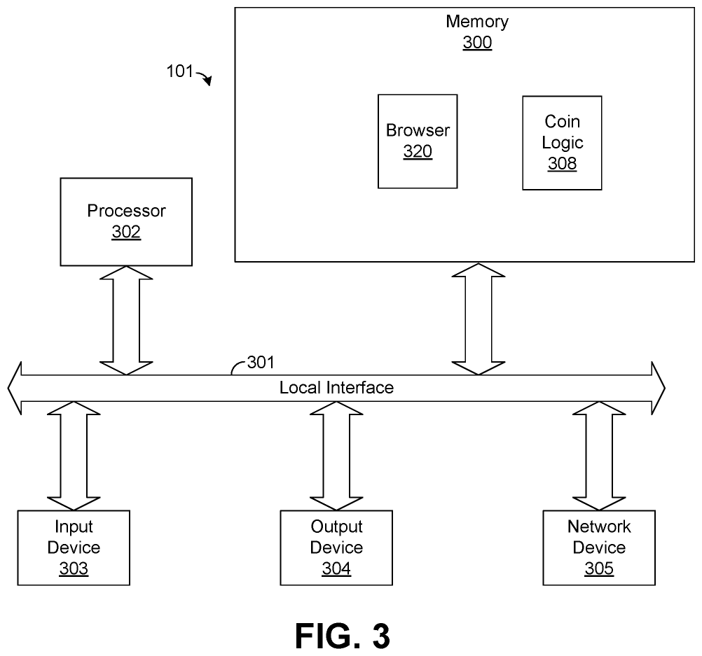

FIG. 3 is a block diagram of an exemplary creator computing device 101 as depicted in FIG. 1. Only the architecture of one of said creator computing devices is discussed here for brevity. Each of the other creator computing devices 102-104 has substantially identical hardware and software as the creator computing device 101.

The exemplary creator computing device 101 comprises a processor 302, an output device 304, an input device 303, a network device 305 and memory 300. Each of these components communicates over local interface 301, which can include one or more buses.

The creator computing device 101 further comprises user logic 308 and browser logic 320. Note that the user logic 308 and the browser logic 320 can be software, hardware, or a combination thereof. In the exemplary creator computing device 101 shown in FIG. 3, user logic 308 is software stored in memory 300. Memory 300 may be of any type of memory known in the art, including, but not limited to random access memory (RAM), read-only memory (ROM), flash memory (for the purpose of mass storage), or the like.

The user logic 308 is shown in FIG. 3 as stored in memory 300. When stored in memory 300, user logic 308 can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions.

In the context of the present disclosure, a non-transitory computer-readable medium can be any means that can contain, store, communicate, propagate, or transport the program for use by or in connection with the instruction execution system, apparatus, or device. This medium does not include signals. The computer readable medium can be, for example but is not limited to, an electronic, magnetic, optical, electromagnetic, infrared, or semiconductor system, apparatus, device, or propagation medium.

Processor 302 may be a digital processor or other type of circuitry configured to run the user logic 308 by processing and executing the instructions of the user logic 308. Further, the processor 302 communicates with and drives the other elements within the creator computing device 101 via the local interface 301.

The network device 305 is any type of device that enables the creator computing device 101 to communicate with the Internet 110 (FIG. 1) and hence with the asset-backed currency computing device 105, the initial transaction computing device 106, the certifier computing device 107, and the block chain verifier computing device(s) 108 over the Internet 110 (FIG. 1). As examples, the network device 305 may enable coupling to a network hub, a network repeater, a network bridge, a network router, a network switch, or the like.

The output device 304 is any type of output device known in the art or future-developed. For example, the output device 304 may include a display device or a speaker device.

The input device 303 is any type of input device known in the art or future-developed. For example, the input device 303 may include a keyboard, a mouse, touchscreen, a speaker, or the like. It is any type of device that allows a user to input data into the asset-backed currency computing device 105.

Note that each of the system components of system 100 will be described in full after each is introduced hereinafter. This includes the operation of the components as a system.

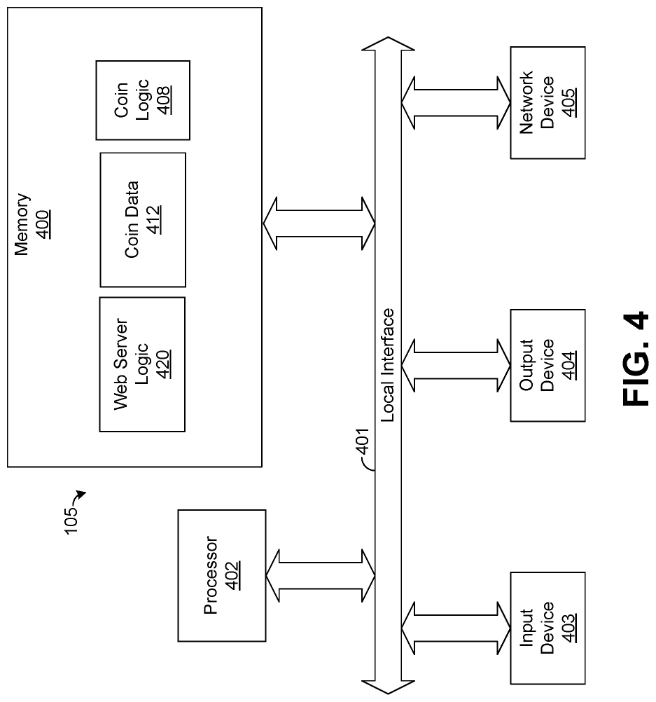

FIG. 4 is a block diagram of an exemplary asset-backed currency computing device 105 as depicted in FIG. 1. The exemplary asset-backed currency computing device 105 may comprise a processor 402, an output device 404, an input device 403, a network interface 405 and memory 400. Each of these components communicates over local interface 401, which can include one or more buses.

The asset-backed currency computing device 105 further comprises coin logic 408, a Web server 420, and coin data 412. Note that the coin logic 408 and the Web server 420 can be software, hardware, or a combination thereof. In the exemplary asset-backed currency computing device 105 shown in FIG. 4, coin logic 408 is software stored in memory 400, and Web server 420 is shown stored in memory 400. Memory 400 may be of any type of memory known in the art, including, but not limited to random access memory (RAM), read-only memory (ROM), flash memory (for the purpose of mass storage), or the like.

The coin logic 408 is shown in FIG. 4 as stored in memory 400. When stored in memory 400, coin logic 408 and Web server logic 420 can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions.

In the context of the present disclosure, a non-transitory computer-readable medium can be any means that can contain, store, communicate, propagate, or transport the program for use by or in connection with the instruction execution system, apparatus, or device. This medium does not include signals. The computer readable medium can be, for example but not limited to, an electronic, magnetic, optical, electromagnetic, infrared, or semiconductor system, apparatus, device, or propagation medium.

Processor 402 may be a digital processor or other type of circuitry configured to run the coin logic 408 by processing and executing the instructions of the coin logic 408. Further, the processor 402 communicates with and drives the other elements within the asset-backed currency computing device 105 via the local interface 401.

The network device 405 is any type of device that enables communication over the Internet 110 (FIG. 1). As examples, the network device may comprise one or more of the following that enable coupling to a network hub, a network repeater, a network bridge, a network router, a network switch, or the like.

The output device 404 is any type of output device known in the art or future-developed. For example, the output device 404 may include a display device or a speaker device.

The input device 403 is any type of input device known in the art or future-developed. For example, the input device 403 may include a keyboard, a mouse, touchscreen, a speaker, or the like. It is any type of device that allows a user to input data into the asset-backed currency computing device 105.

In one embodiment, as mentioned previously, the asset-backed currency device 105 may comprise the Web server 420. The Web server 420 enables communication with potential coin owners through a series of GUIs.

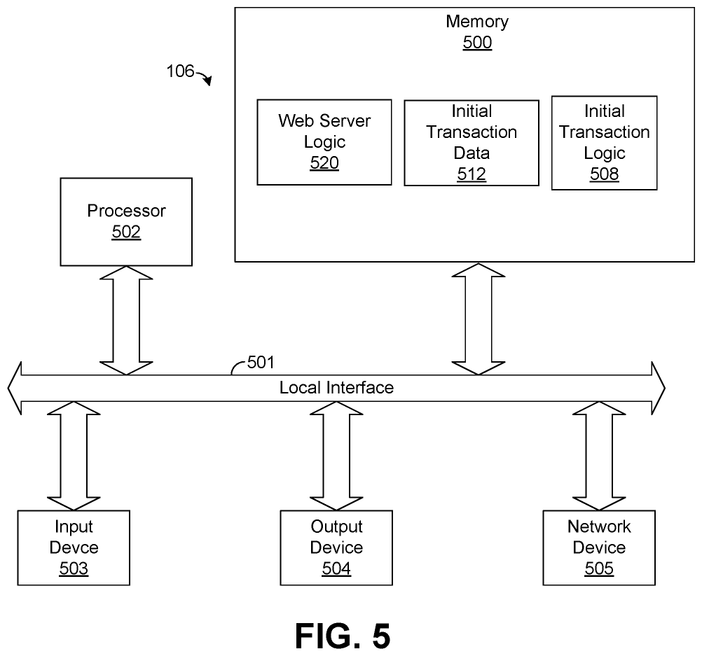

FIG. 5 is a block diagram of an exemplary initial transaction computing device 106 as depicted in FIG. 1. The exemplary initial transaction computing device 106 may comprise a processor 502, an output device 504, an input device 503, a network device 505 and memory 500. Each of these components communicates over local interface 501, which can include one or more buses.

The initial transaction computing device 106 further comprises initial transaction logic 508, a Web server 520, and initial transaction data 512. Note that the initial transaction logic 508 and the Web server 520 can be software, hardware, or a combination thereof. In the exemplary initial transaction computing device 106 shown in FIG. 5, initial transaction logic 508 is software stored in memory 500, and Web server logic is software stored in memory 500. Memory 500 may be of any type of memory known in the art, including, but not limited to random access memory (RAM), read-only memory (ROM), flash memory (for the purpose of mass storage), or the like.

The initial transaction logic 508 and the Web server 520 are shown in FIG. 5 as stored in memory 500. When stored in memory 500, initial transaction logic 508 and the Web server 520 can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions.

In the context of the present disclosure, a non-transitory computer-readable medium can be any means that can contain, store, communicate, propagate, or transport the program for use by or in connection with the instruction execution system, apparatus, or device. This medium does not include signals. The computer readable medium can be, for example but not limited to, an electronic, magnetic, optical, electromagnetic, infrared, or semiconductor system, apparatus, device, or propagation medium.

Processor 502 may be a digital processor or other type of circuitry configured to run the initial transaction logic 508 and the Web server 520 by processing and executing the instructions of the initial transaction logic 508 and the Web server 520. Further, the processor 502 communicates with and drives the other elements within the initial transaction computing device 106 via the local interface 501.

The network device 505 is any type of device that enables communication over the Internet 110 (FIG. 1). As examples, the network device may comprise one or more of the following that enable coupling to a network hub, a network repeater, a network bridge, a network router, a network switch, or the like.

The output device 504 is any type of output device known in the art or future-developed. For example, the output device 504 may include a display device or a speaker device.

The input device 503 is any type of input device known in the art or future-developed. For example, the input device 503 may include a keyboard, a mouse, touchscreen, a speaker, or the like. It is any type of device that allows a user to input data into the initial transaction computing device 106.

In one embodiment, as mentioned previously, the initial transaction computing device 106 may comprise the Web server 520. The Web server 520 enables communication with potential coin owners through a series of GUIs and the user's Web browser 320 (FIG. 3).

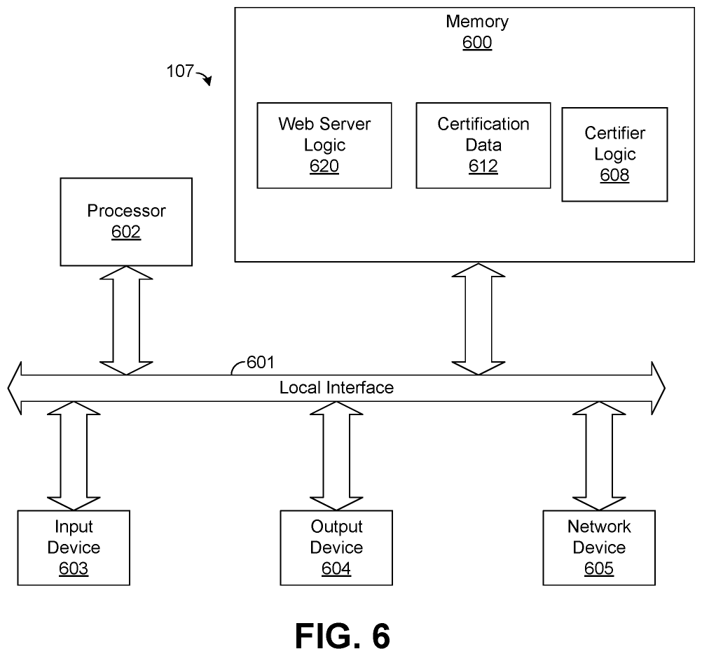

FIG. 6 is a block diagram of an exemplary certifier computing device 107 as depicted in FIG. 1. The exemplary certifier computing device 107 may comprise a processor 602, an output device 604, an input device 603, a network device 605 and memory 600. Each of these components communicates over local interface 601, which can include one or more buses.

The certifier computing device 107 further comprises certifier logic 608, Web server 620, and certification data 612. Note that the certifier logic 608 and the Web server 620 can be software, hardware, or a combination thereof. In the exemplary certification computing device shown in FIG. 6, certifier logic 608 is software stored in memory 600, and Web server logic 620 is software shown stored in memory 600. Memory 600 may be of any type of memory known in the art, including, but not limited to random access memory (RAM), read-only memory (ROM), flash memory (for the purpose of mass storage), or the like.

The certifier logic 608 is shown in FIG. 6 as stored in memory 600. When stored in memory 600, certifier logic 608 and Web server logic 620 can be stored and transported on any computer-readable medium for use by or in connection with an instruction execution system, apparatus, or device, such as a computer-based system, processor-containing system, or other system that can fetch the instructions the instruction execution system, apparatus, or device and execute the instructions.

In the context of the present disclosure, a non-transitory computer-readable medium can be any means that can contain, store, communicate, propagate, or transport the program for use by or in connection with the instruction execution system, apparatus, or device. This medium does not include signals. The computer readable medium can be, for example but not limited to, an electronic, magnetic, optical, electromagnetic, infrared, or semiconductor system, apparatus, device, or propagation medium.

Processor 602 may be a digital processor or other type of circuitry configured to run the certifier logic 608 and the Web server 620 by processing and executing the instructions of the certifier logic 608 and the Web server 620. Further, the processor 602 communicates with and drives the other elements within the certification computing device 107 via the local interface 601.

The network device 605 is any type of device that enables communication over the Internet 110 (FIG. 1). As examples, the network device may comprise one or more of the following that enable coupling to a network hub, a network repeater, a network bridge, a network router, a network switch, or the like.

The output device 604 is any type of output device known in the art or future-developed. For example, the output device 604 may include a display device or a speaker device.

The input device 603 is any type of input device known in the art or future-developed. For example, the input device 603 may include a keyboard, a mouse, touchscreen, a speaker, or the like. It is any type of device that allows a user to input data into the certification computing device 107.

In one embodiment, the certification computing device 107 may comprise the Web server logic 620. The Web server logic 620 enables communication with potential coin owners through a series of GUIs.

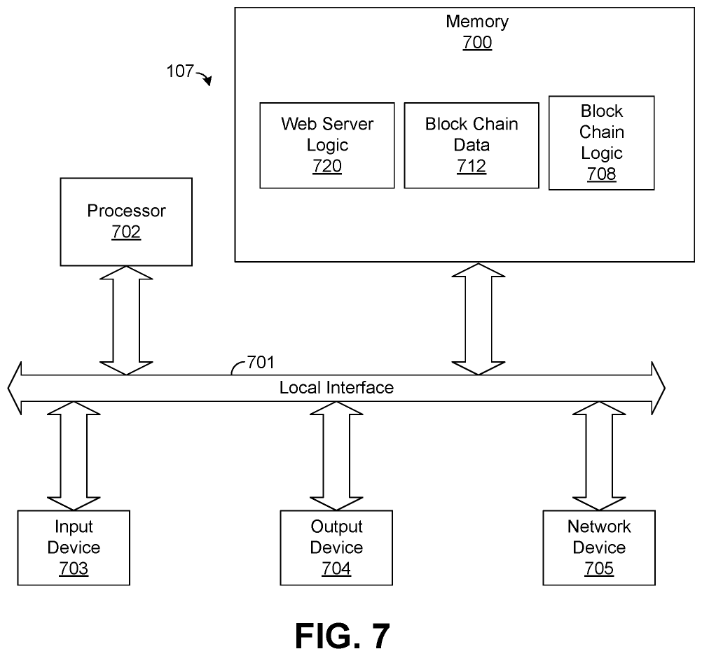

FIG. 7 is a block diagram of an exemplary block chain verifier computing device 108 as depicted in FIG. 1. The exemplary block chain verifier computing device 108 may comprise a processor 702, an output device 704, an input device 703, a network device 705 and memory 700. Each of these components communicates over local interface 701, which can include one or more buses.

The block chain verifier computing device 108 further comprises block chain logic 708. Web server 720, and block chain data 712. Note that the block chain logic 708 and the Web server 720 can be software, hardware, or a combination thereof. In the exemplary block chain verifier computing device 108 block chain logic 708 shown in FIG. 7, block chain logic 708 is software stored in memory 700, and Web server logic 720 is software shown stored in memory 700. Memory 700 may be of any type of memory known in the art, including, but not limited to random access memory (RAM), read-only memory (ROM), flash memory (for the purpose of mass storage), or the like.

The block chain logic 708 is shown in FIG. 7 as stored in memory 700. When stored in memory 700, block chain logic 708 and Web server logic 720 can be stored and transported on any computer-readable medium for use by or in connection with an instruction execution system, apparatus, or device, such as a computer-based system, processor-containing system, or other system that can fetch the instructions the instruction execution system, apparatus, or device and execute the instructions.

In the context of the present disclosure, a non-transitory computer-readable medium can be any means that can contain, store, communicate, propagate, or transport the program for use by or in connection with the instruction execution system, apparatus, or device. This medium does not include signals. The computer readable medium can be, for example but not limited to, an electronic, magnetic, optical, electromagnetic, infrared, or semiconductor system, apparatus, device, or propagation medium.

Processor 702 may be a digital processor or other type of circuitry configured to run the block chain logic 708 and the Web server 720 by processing and executing the instructions of the block chain logic 708 and the Web server 720. Further, the processor 702 communicates with and drives the other elements within the block chain verifier computing device 108 via the local interface 701.

The network device 705 is any type of device that enables communication over the Internet 110 (FIG. 1). As examples, the network device may comprise one or more of the following that enable coupling to a network hub, a network repeater, a network bridge, a network router, a network switch, or the like.

The output device 704 is any type of output device known in the art or future-developed. For example, the output device 704 may include a display device or a speaker device.

The input device 703 is any type of input device known in the art or future-developed. For example, the input device 703 may include a keyboard, a mouse, touchscreen, a speaker, or the like. It is any type of device that allows a user to input data into the block chain verifier computing device 108.

In one embodiment, the block chain verifier computing device 108 may comprise the Web server logic 720. The Web server logic 720 enables the block chain logic 708 to publicly make available the block chain data 712 as blocks are added to the chain. There will often be multiple block chain verifiers competing to receive a fee awarded to the verifier that is the first to complete the corresponding “proof of work” task.

In operation, a user who desires to create coins navigates using the creator computing device 101-104 to the asset-backed currency computing device 105 (FIG. 4). The user responds to one or more GUIs displayed by the Web Server 420 over the Internet 110 (FIG. 1). Inevitably, the user may have an account and is logged onto the asset-back currency computing device 105. As an example, the user may wish to create 100 coins. Thus, the user enters 100 coins into a GUI displayed by the Web Server 420.

In response to the user expressing the desire to create 100 coins, the coin logic 408 stores data in the coin data 412 identifying the user and the number of coins the user wishes to create.

Thereafter, the coin logic 408 transmits a message to the initial transaction computing device 106 comprising data identifying the user, e.g., an internet protocol address (IP address), the number of coins, and a request to create coins.

In response, the initial transaction logic 508 prompts the user by his IP address and displaying a GUI through its Web server at the creator computing device 101 that requests a creation fee. In this regard, the initial transaction logic 508 requests a creation fee. Architecturally, the initial transaction computing device's main purpose is the levying of the creation fee based upon the number of coins the user has created. The Web server 520 displays a GUI to the creator computing device' browser. In response, the coin creator can use varying modes of payment to pay the levied creation fee, e.g., credit card, debit card, electronic check, or the like. Note that the initial transaction computing device 106 is concerned only with the coin creation and not with certification or with any use made of the coin after creation.

Once fees have been paid, the initial transaction logic 508 transmits a message to the block chain verifier computing device 108. (Or the initial transaction logic 508 can simply make that message data available to the networked block chain verifier computing devices.) The message may contain the creator's name, the payment, and other information used by the block chain verifier computing device 108 to add a block to the block chain 200 (FIG. 2). Notably, an initial transaction is represented in the chain 200 by a particular block as described hereinabove. However, the block chain is anonymous.

Coin certification is optional. If the coin creator wishes to have the coins certified, then following the creation of the block in the block chain 200, the certifier computing device 107 is provided all information necessary to certify the transaction, i.e., back the transaction with assets owned by the creator (user). There are several ways this could occur. First, the certifier computing device 107 could request documents of proof of assets, which the creator provides. Electronic verification may occur to determine initial validity of the documents. In addition, a user of the certifier computing device 107 may manually verify the assets for backing.

In return for certifying a given amount of coin, the certifier contractually constrains assets that the creator has designated as backing for the coins created. Further, the certifier computing device 107 levies a certification fee on the creator. Certified backing is described hereinabove.

As discussed further hereinabove, most of the creation fee levied on the user is transmitted electronically to the block chain verifier computing device 108 that wins the corresponding “proof of work” contest for block chain maintenance.

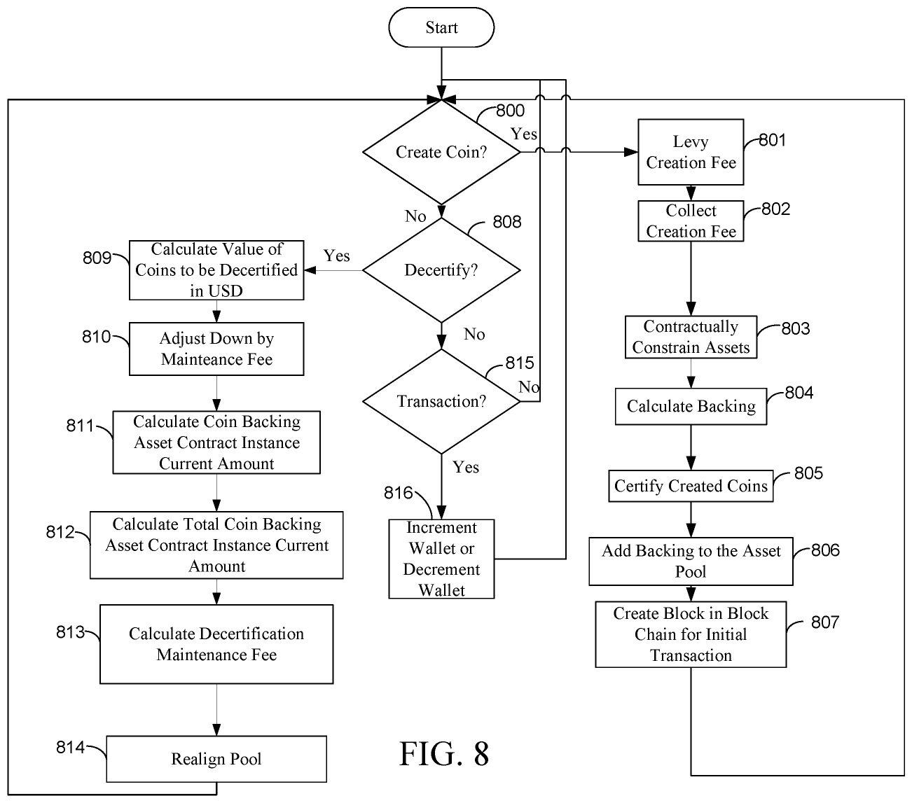

FIG. 8 depicts exemplary architecture and functionality of the asset-backed currency system 100 described hereinabove.

In step 800 the coin logic 308 (FIG. 3) receives a request from a creator (potential owner) of asset-backed coins. If the creator desires to create asset-backed coins, the coin logic 308 transmits a GUI to the creator via computing device 101 in which the creator enters the amount of coin the creator desires.

Based upon the amount of coin the creator desires, the initial transaction logic 508 calculates a creation fee. In step 801, the initial transaction logic 508 levies the creation fee on the creator. In this regard, the coin logic 408 transmits a GUI to the creator computing device 101 requesting payment of the creation fee and modes of payment, e.g., PayPal®, debit card, credit card, or other form of payment. In step 802, the initial transaction logic 408 collects the creation fee.

The initial transaction logic 508 transmits data to the certification computing device 107 comprising information related to the initial transaction, e.g., the amount of coin the creator desires and identifying information of the creator. The certification computing device 107 is responsible for contractually constraining the assets in step 803. In this regard, the data transmitted to the certifier computing device 107 may contain data indicative of assets. In another embodiment, the certifier logic 608 (FIG. 6) may transmit a message to the creator via a GUI that requests documents indicative of assets to be used for backing the coins created.

The certifier logic 608 calculates backing in step 804. Note that the certified backing is equal to the product of the asset local currency value, the pledged fraction, the coin fraction value, the coin local currency ratio, and the asset volatility factor.

Based on the calculated backing, the certifier logic 608 certifies the number of created coins that correspond to the certified backing in step 805. In certifying the coins, the certification logic 608 assigns unique serial numbers to each of the coins created that are backed.

In step 806, the initial transaction logic 508 adds the backing calculated to the asset pool, which contains all creation backing (or replacement backing) over every creator who has created coins using the system 100 (FIG. 1). Note that the certified coins are backed by the asset pool. They are not backed by the specific assets contractually pledged by the creator to the certifier to support certification of the coins.

In step 807, the certifier logic 608 notifies the block chain logic 708 to create a block. In step 807, the block chain logic 708 creates a block 203 (FIG. 2) that represents the initial transaction. This block references the prior block in the block chain 200 (FIG. 2). Note that the block chain 200 is publicly available.

In step 808, the coin owner may desire to decertify one or more coins contained in his/her wallet. The wallet software or asset backed computing device 105 transmits a message, via a GUI, that the coin owner desires to decertify a particular amount of coin. In response, in step 809, the certifier calculates the value, in USD, of the coins to be decertified. That value is set to the product of C_DV_USD and the number of coins to be decertified. (Here C_DV_USD is the decertification value, in USD, of one coin. That value is set by the certifier.)

In step 810 the certifier adjusts the amount, in USD, to be transferred to the coin owner for coin decertification. In this regard, the coin owner pays a decertification fee, and the certifier downwardly adjusts the amount to be transferred to the coin owner by that assessed decertification fee. (A legal person can only decertify coins that are currently owned by that legal person.)

In step 811, the certifier logic 508 calculates the coin backing asset contract instance current amount (C_BA_CI_CA). This is the current number of coins for which the creator is obligated to provide backing for a given coin backing asset contract instance. (Here a coin backing asset contract instance (C_BA_CI) is the event where a creator pledges assets owned by the creator as backing for some amount of coin.) At the time of certification, the coin backing asset contract instance current amount is set to the value of the coins of the certified backing. However, C_BA_CI_CA is reduced by any coin decertification maintenance fees corresponding to that backing asset contract instance that are the paid to the certifier.

In step 812, the certifier logic 608 calculates the TOTAL Full-Coin Backing Asset Contract Instance Current Amount (TOTAL_FC_BA_CI_CA). This is defined to be sum of all the Full-Coin Backing Asset Contract Instance Current Amounts (where that sum is taken over all FC_BA_CI's where the asset pledge agreement is still applicable.) This quantity is measured in Full-Coins.

In step 813, the certifier logic 608 calculates the decertification maintenance fee to be assessed on the creators whose assets belong to the asset pool. In step 814, the certifier logic 608 realigns the pool by removing from the asset pool any assets for which the asset portion that is obligated to serve as coin backing is zero. (This happens when the C_BA_CI_CA for that asset is zero.) (Assets can also be removed from the asset pool by payment of a coin backing asset termination fee.)

In step 815, a coin owner may desire to enter a transaction wallet-to-wallet. In so doing, the asset pool will remain unchanged. In step 816, the creator computing device 101 would increment or decrement the coins in its respective wallet based upon the transaction. The creator computing device and its wallet are used by all coin owners. A coin owner may have created the coins or may have acquired them.

What is claimed is:

1. A cryptocurrency system, comprising: [a] One or more Creator Computing Devices, [b] One or more Asset-Backed Computing Devices, [c] One or more Initial Transaction Computing Devices, [d] One Certifier Entity employing a Certifier Computing Device, and [e] One or more Block-Chain Verifier Computing Devices.

2. The cryptocurrency system of claim 1, wherein each Creator Computing Device as in claim 1, can be used by legal persons to create coins of digital currency. Each Creator Computing Device transfers coin creation information to one or more Initial Transaction Computing Devices.

3. The cryptocurrency system of claim 1, wherein the one or more Asset Backed Currency Computing Devices make coin software available to the Creator Computing Devices, Initial Transaction Computing Devices, the Certifier and to legal persons, and each Asset Backed Currency Computing Device, and its supporting infrastructure, is funded by part of the Creation Fee that is levied by the Creator Computing Device onto legal persons that create coins.

4. The cryptocurrency system of claim 1, wherein each Initial Transaction Computing Device levy's a Creation Fee on coin creators that use that device.

5. The cryptocurrency system of claim 1, wherein the Certifier Entity featuring one Certifier Computing Device that certifies the asset backing of coins by contractually constraining the assets pledged by coin creators for said backing and that entity levy's a Certification Fee upon coin creators wishing to certify coins they created.

6. One Certifier Entity, as in claim 1, featuring one Certifier Computing Device that determines the certified backing (measured in coin), for a given pledged asset as follows: That Certified_Backing is product of five numbers: [a] the Asset_LC_Value (ALCV), [b] the Pledged_Fraction (PL_FRAC), [c] the C_Fraction (C_FRAC), [d] the Coin_LC_Ratio (C_LCR) and [e] the Asset_Volatility_Factor (AVF): Thus Certified_Backing=Asset_LC_Value×Pledged_Fraction×C_Fraction×Coin_LC_Ratio×Asset_Volatility_Factor, and is expressed symbolically as CB=ALCV·PL_FRAC·FC FRAC·FC_LCR·AVF

7. The cryptocurrency system of claim 6, where the Certifier Entity comprises one Certifier Computing Device that determines the asset local currency value (ALCV), and ALCV is defined to be the value of a pledged asset in US Dollars (USD) or other government-issued currency.

8. The cryptocurrency system of claim 6, wherein the Certifier Entity comprises one Certifier Computing Device that uses the Pledged_Fraction (PL_FRAC) that is provided by the coin owner wishing to certify coin(s).

9. The cryptocurrency system of claim 6, wherein the Certifier Entity comprises one Certifier Computing Device that sets the value of C_Fraction (C_FRAC). The quantity C_FRAC is the fraction of the pledged amount that is acceptable to the certifier to be used as coin backing. Here the pledged amount is equal to ALCV·PL_FRAC.

10. The cryptocurrency system of claim 6, wherein the Certifier Entity comprises one Certifier Computing Device that sets the value of the coin local currency ratio (C_LCR). That ratio, in USD, is represented as C_per_USD.

11. The cryptocurrency system of claim 6, wherein the Certifier Entity comprises one Certifier Computing Device that sets the value of the Asset Volatility Factor (AVF).

12. The cryptocurrency system of claim 1, wherein the Certifier Entity combines the pledged assets that back coins into a Backing Asset Pool (BAP).

13. The cryptocurrency system of claim 12, wherein the Certifier permits the owners of certified coins to decertify those coins, and the Certifier levy's a Decertification Fee upon the coin owners wishing to decertify those coins.

14. The cryptocurrency system of claim 13, wherein the Certifier determines the value, in USD, of each certified coin undergoing decertification, and a value, in USD, is C_DV_USD, which is set by the certifier and can be changed as the certifier sees fit.

15. The cryptocurrency system of claim 1, wherein, the Certifier transfers the value in USD, of coins being decertified, to the owners of those coins.

16. The cryptocurrency system of claim 13, wherein the Certifier levy's a decertification maintenance fee the current owners of assets in the coin backing asset pool, and For a given coin backing asset contract instance, the decertification maintenance fee is equal to the total time interval decertification maintenance fee multiplied by the coin backing asset contract instance current amount divided by the sum of all current amounts, TOTAL C_BA_CI_CA and, the total time interval decertification maintenance fee, for a given time interval, is defined to be the value transferred by the Certifier to the owners of Coins being decertified in that time interval. The decertification maintenance fee is levied on each creator (or backing asset holder) who is still present in the coin pool.

17. The cryptocurrency system of claim 1, wherein the Certifier maintains the publicly available Coin Certification/Decertification Database (CCD_DB). The records in that database include the Coin certification identifiers, date of certification, the Coin owners name and wallet address, and Coin Asset Backing descriptive data, and decertification is likewise documented in the CCD_DB. Certification identifiers assigned to Coins retain those associations forever, regardless of whether those Coins are subsequently decertified.

18. The cryptocurrency system of claim 13, wherein the Certifier may approve the replacement of current Coin Backing Assets (CBA) by other assets owned by the owners of the current Coin Backing Assets, and it is the Certifier's decision whether or not to approve such replacement, and if approved, the replacement CBA would be subject to the same legal conditions as are assets pledged as backing for newly created Coins, and the modification of Coin Backing Assets would also need to be duly recorded and displayed in the CCD_DB, as well as in the Coin Block-Chain.

19. The cryptocurrency system of claim 13, wherein the Certifier may approve the replacement of the owners of Coin Backing Assets by other owners of assets, and these other owners would need to provide Coin Backing Assets and submit to the certification process currently used for Coins. In the case of the death of a Coin Backing Asset owner, the assets offered by the replacement owner(s) might be the same assets that were owned by the former Coin Backing Asset Holder(s).

20. The cryptocurrency system of claim 13, wherein the Certifier may approve replacement of a deceased owner of coin backing assets by the inheritors of those assets, and the phrase “Coin Backing Assets Holders” (C_BAHs) refers to the current owners of assets pledged as Coin Backing, and upon the death of a C_BAH, the estate of the C_BAH is the replacement C_BAH. The inheritors of the CBA can request to be designated as replacement C_BAH for the coins backed by the assets, but if all the inheritors of the CBA do not wish to serve as C_BAH, then these holders and the assets are subject to a Coin Backing Asset Termination Fee, and for each C_BA_CI, that fee equals the Coin Backing Asset Contract Instance Current Amount (C_BA_CI_CA). That amount is measured in Full-Coins, but it can be expressed as an equivalent amount of USD, and that USD equivalent amount is determined at the time the Termination Fee is levied.

21. The cryptocurrency system of claim 20, wherein the Certifier may grant a Termination of Asset Pledge provided that the Creator or successor Backing Asset Holders pay a Coin Backing Asset Termination Fee to the CERTIFIER, and in this case the Coins for which the assets were pledged retain their certified status, and the Certifier becomes the Backing Asset Holder for the assets that replace the assets whose pledge was terminated, and those replacement assets are the corresponding Coin Backing Asset Termination Fee that was paid to the Certifier.

22. The cryptocurrency system of claim 1, wherein one or more Block-Chain Verifier Computing Devices record and account for coin creation, certification, decertification and transactions, and the Block-Chain Verifier Computing Devices may incorporate into the software execution parts of the open source bitcoin software infrastructure.

23. The cryptocurrency system of claim 22, wherein One or more Block-Chain Verifier Computing Devices maintain the blockchain by a public networked means, and these Block-Chain Verifiers each attempt to furnish a “proof of work” that is needed to construct a block and add it to the blockchain that public consensus holds as being the current coin blockchain, and that procedure is similar to the maintenance procedure of the bitcoin block-chain, except that a reward to the Block-Chain Verifier that completes the “proof of work” is furnished by a Transaction Fee levied on those that use coins in transactions, wherein corresponding bitcoin reward is furnished by another means.

24. The cryptocurrency system of claim 23, wherein One or more Block-Chain Verifier Computing Devices that maintain the blockchain using blocks that contain the following entities or fields:
[a] Zero or more Full-Coin creation transactions
[b] Zero or more spending transactions
[c] Zero or more certification identifiers and supporting information
[d] Zero or more decertification identifiers and supporting information
[e] Computational proof or work
[f] Reference to the chronologically prior Full-Coin block.
